(19) United States
(12) Patent Application Publication
(10) Pub. No.: US 2018/0172993 A1
(43) Pub. Date: Jun. 21, 2018

(54) SIDE VIEW SAFETY DISPLAY IN A MOTOR VEHICLE

(71) Applicant: Panasonic Automotive Systems Company of America, Division of Panasonic Corporation of North America, Peachtree City, GA (US)

(72) Inventors: WALTER JOSEPH NILL, DAVISON, MI (US); DAVID KAY LAMBERT, STERLING HEIGHTS, MI (US); STEPHANIE TUTTLE, CANTON, MI (US)

(73) Assignee: Panasonic Automotive Systems Company of America, Division of Panasonic Corporation of North America

(21) Appl. No.: 15/846,474

(22) Filed: Dec. 19, 2017

Related U.S. Application Data
(60) Provisional application No. 62/436,775, filed on Dec. 20, 2016.

(51) Int. Cl. G02B 27/01; B60R 1/00; B62D 25/04

(52) U.S. Cl. CPC G02B 27/0149; B60R 1/00; B62D 25/04; G02B 27/0103; B60R 2300/202; G02B 2027/0138; B60R 2300/802; B60R 2300/8046; B60R 2300/8066; G02B 2027/0161; B60R 2300/205

(57) ABSTRACT

A motor vehicle includes an A-pillar disposed between a side view window and a windshield. A virtual image projection arrangement presents a virtual image that is visible by a driver of the vehicle in a direction adjacent to the A-pillar and appearing to the driver to be at least two meters away from the driver.

### CROSS-REFERENCE TO RELATED APPLICATIONS

This application claims the benefit of U.S. Provisional Application No. 62/436,775, filed on Dec. 20, 2016, which the disclosure of which is hereby incorporated by reference in its entirety for all purposes.

### FIELD OF THE INVENTION

The disclosure relates to a display system for a vehicle, and, more particularly, to a display system which may present images on glass windows and the windshield of the vehicle.

### BACKGROUND OF THE INVENTION

Current practice is to either use a side-view mirror, or to use a camera and a direct-view display (not transparent) to replace the side-view mirror. The direct-view display must be large enough to provide the necessary field-of-view, but it must not obscure the driver's vision of other information needed for safe driving. The direct-view display must fit in the space available in the vehicle. This many times is a very large challenge.

At the present time, 49 CFR 571.111—Standard No. 111; Rearview mirrors, describes the legal requirement for side-view mirrors on vehicles sold in the United States. Vehicles are required to have a flat side-view mirror on the driver's side. If the rear-view mirror inside the vehicle does not meet certain requirements, the vehicle is also required to have a side-view mirror on the passenger side.

There is a world-wide trend to move from outside side-view mirrors to a replacement system with side-view cameras and associated displays inside the vehicle. In Japan, exterior side-view mirrors are no longer required. In Europe, some vehicles no longer have exterior side-view mirrors. It is anticipated that vehicle safety regulations in the United States will be changed to follow this trend. However exterior side-view mirrors are currently required in the United States.

### SUMMARY

The present invention may provide an apparatus to display visual information to a driver, similar to the view currently presented by conventional side-view mirrors. However, the present invention could replace the side-view mirror on the driver-side and/or passenger-side of the vehicle. In place of the mirrors could be sensors such as hi-resolution camera(s) with optics specifically designed for the optimum angle of view of the area of interest. The image could be projected to the driver in a Head Up Display.

The present invention may provide a display that appears to the driver as outside a vehicle's windshield or window glasses, wherein an electronic controller controls the content of the display. The content can be in the form of entertainment/news video, external driving conditions, and/or infotainment messages. The controller can turn off the video/messages and make the display transparent so that the passengers of the vehicle can view the road. The turning on and turning off of the video/messages can be based on external driving conditions or a user request.

In one embodiment, the invention comprises a motor vehicle including an A-pillar disposed between a side view window and a windshield. A virtual image projection arrangement presents a virtual image that is visible by a driver of the vehicle in a direction adjacent to the A-pillar and appears to the driver to be at least two meters away from the driver.

In another embodiment, the invention comprises a method of presenting information to a driver of a motor vehicle having an A-pillar disposed between a side view window and a windshield. The method includes capturing images of a scene behind the motor vehicle. A virtual image is presented dependent upon the captured images. The virtual image is visible by a driver of the vehicle in a direction adjacent to the A-pillar and appears to the driver to be at least two meters away from the driver.

In yet another embodiment, the invention comprises a motor vehicle including an external camera positioned to capture images in a rearward direction. An A-pillar is disposed between the side view window and the windshield. An electronic processor receives the images captured by the camera. A virtual image projection arrangement is communicatively coupled to the electronic processor and presents a virtual image dependent upon the images captured by the camera. The virtual image is visible by a driver of the vehicle in a direction adjacent to and inboard of the A-pillar. The virtual image appears to the driver to be disposed at a distance of at least one foot beyond the windshield.

### BRIEF DESCRIPTION OF THE DRAWINGS

A better understanding of the present invention will be had upon reference to the following description in conjunction with the accompanying drawings.

FIG. 1 is an overhead schematic view of one embodiment of a windshield/window video display arrangement of the present invention.

FIG. 2 is a plan view of one example embodiment of a virtual image produced by the left side HUD of FIG. 1 according to the present invention.

FIG. 3 is a block diagram of another example embodiment of a windshield/window video display arrangement of the present invention.

FIG. 4 is a block diagram of yet another example embodiment of a windshield/window video display arrangement of the present invention.

FIG. 5 is a block diagram of still another example embodiment of a windshield/window video display arrangement of the present invention.

FIG. 6 is a block diagram of a further example embodiment of a windshield/window video display arrangement of the present invention.

FIG. 7 is a block diagram of another example embodiment of a windshield/window video display arrangement of the present invention.

FIG. 8 is a block diagram of yet another example embodiment of a windshield/window video display arrangement of the present invention.

FIG. 9 is a flow chart of one example embodiment of a method of the invention for presenting information to a driver of a motor vehicle.

### DETAILED DESCRIPTION OF THE PREFERRED EMBODIMENTS

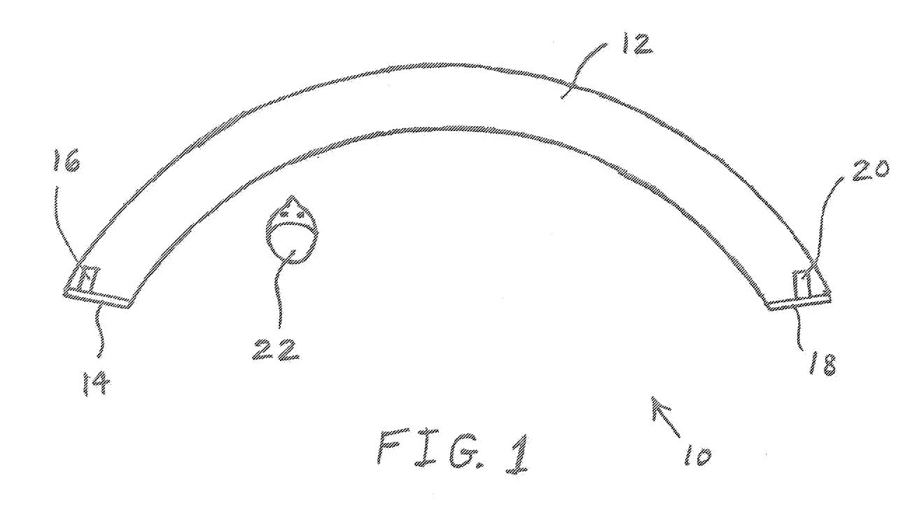

FIG. 1 illustrates one embodiment of a vehicular windshield/window video display arrangement 10 of the present invention, including a windshield 12 disposed between a left side A-pillar 14 adjacent a left side head up display (HUD) 16 and a right-side A-pillar 18 adjacent a right-side HUD 20. A driver 22 is conventionally positioned relative to windshield 12, and is able to see the virtual images produced by HUDs 16 and 20.

Instead of using an actual mirror outside of the vehicle to reflect the rearward scene to the driver, in one embodiment, the information is presented as an image on head up displays (HUDs) 16, 20, inboard from A-pillars 14, 18 of the vehicle (e.g., on a side of A-pillars 14, 18 that is closer to a longitudinal axis of the vehicle, or that is further forward). Additional information can be included in the displayed image to help improve traffic safety.

Each HUD 16, 20 is positioned so the virtual image produced thereby can be seen by the driver if he turns his head to look at the HUD. The driver may use a HUD to view a camera image that replaces the conventional side-view mirror. Not shown is a video camera associated with each display, and an image processing system that may combine the video signal with other information to create an image that is presented to the driver.

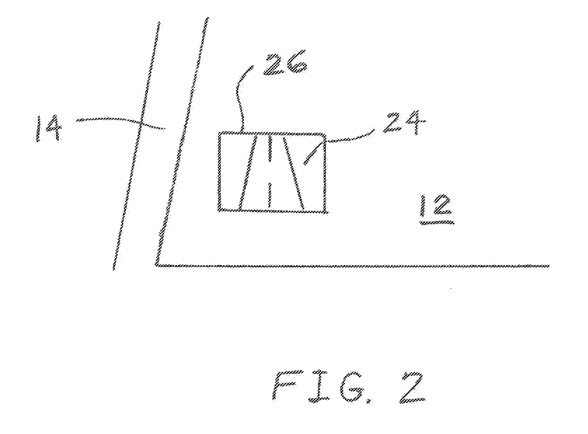

FIG. 2 illustrates a plan view of one example embodiment of a virtual image produced by the left side HUD of FIG. 1 on windshield 12 according to the present invention. FIG. 2 illustrates the view of the virtual image as seen by the driver.

A displayed camera image 24 may be surrounded by a visible rectangular border 26. Visible border 26 surrounds the perimeter of displayed camera image 24 to help the driver quickly differentiate camera image 24 from the remainder of the background scene. Image 24 appears near the inboard side of left side A-pillar 14. The displayed camera image 24 is surrounded by visible border 26 to help the driver distinguish the side-view scene from objects seen through the front windshield.

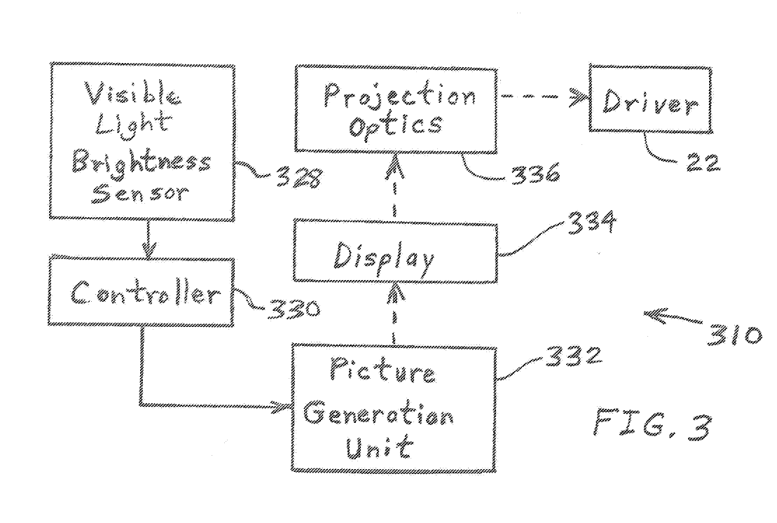

FIG. 3 illustrates another example embodiment of a windshield/window video display arrangement 310 of the present invention, including a visible light brightness sensor 328, an electronic controller 330, a picture generation unit 332, a display screen 334, and projection optics 336 creating a virtual image visible by a human driver 22. The brightness of the image is controlled by controller 330 so the image is clearly visible against the background scene. Sensor 328 may measure the brightness of the outside scene and controller 330 may control the brightness of the image presented to the driver to ensure visibility of the side-view camera image.

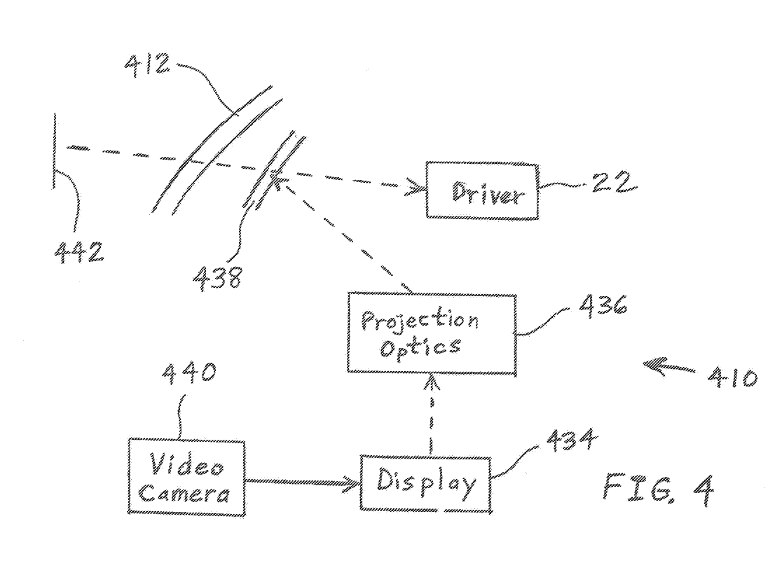

FIG. 4 illustrates yet another example embodiment of a windshield/window video display arrangement 410 of the present invention, including a front windshield 412, a transparent combiner 438, a video camera 440, a display screen 434, and projection optics 436 creating a virtual image 442 that appears to a human driver 22 to be disposed outside of windshield 412. The invention may include various known technologies to create a transparent image. In one embodiment, a combiner HUD is located near an A-pillar, inboard. As shown in FIG. 4, the combiner HUD uses transparent combiner 438 (separate from windshield 412) to create virtual image 442 to be seen by driver 22. The presented virtual image may correspond to the side-view camera, and may be superimposed over the outside scene.

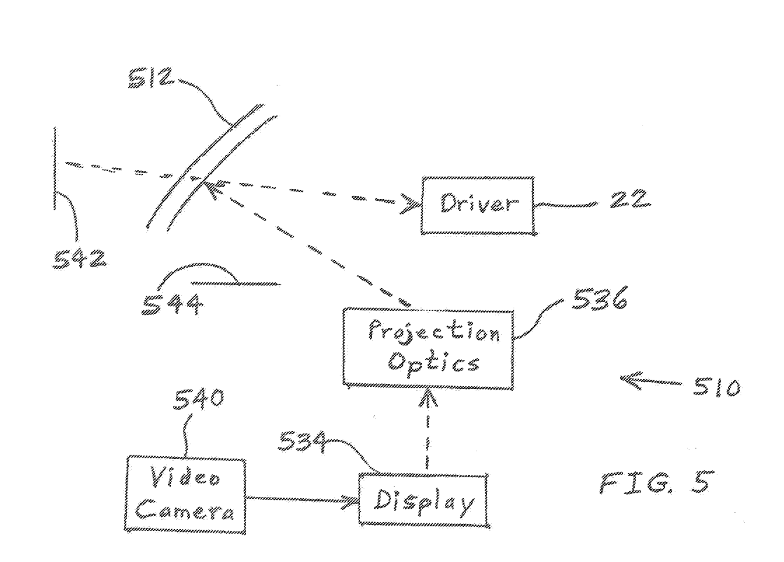

FIG. 5 illustrates still another example embodiment of a windshield/window video display arrangement 510 of the present invention, including a front windshield 512, a dashboard top surface 544, a video camera 540, a display screen 534, and projection optics 536 creating a virtual image 542 that appears to a human driver 22 to be disposed outside of windshield 512. A windshield HUD near an A-pillar reflects light off of windshield 512 to create virtual image 542 to be seen by driver 22. Windshield/window video display arrangement 510 provides a windshield HUD in which a projector located under the dashboard, near an A-pillar, reflects light off of front windshield 512 to present the image from the corresponding side-view camera to the driver, superimposed over the outside scene.

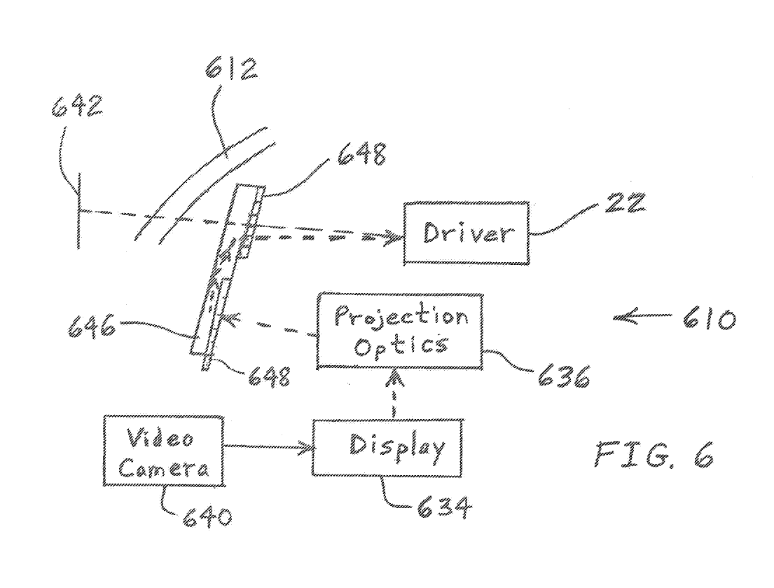

FIG. 6 illustrates yet another example embodiment of a windshield/window video display arrangement 610 of the present invention, including a front windshield 612, a transparent waveguide 646 with grating 648, a video camera 640, a display screen 634, and projection optics 636 creating a virtual image 642 that appears to a human driver 22 to be disposed outside of windshield 612. Windshield/window video display arrangement 610 provides a HUD that uses waveguide optics to create a virtual image 642 that is seen by driver 22. Optical waveguide 646 is used to present virtual image 642 from a side-view camera 640 superimposed over the visible scene outside front windshield 612. Virtual image 642 may be seen by driver 22 near an A-pillar, on the inboard side, superimposed over the outside scene. Gratings 648 couple light from projection optics 636 into, and out of, waveguide 646 to be seen by driver 22.

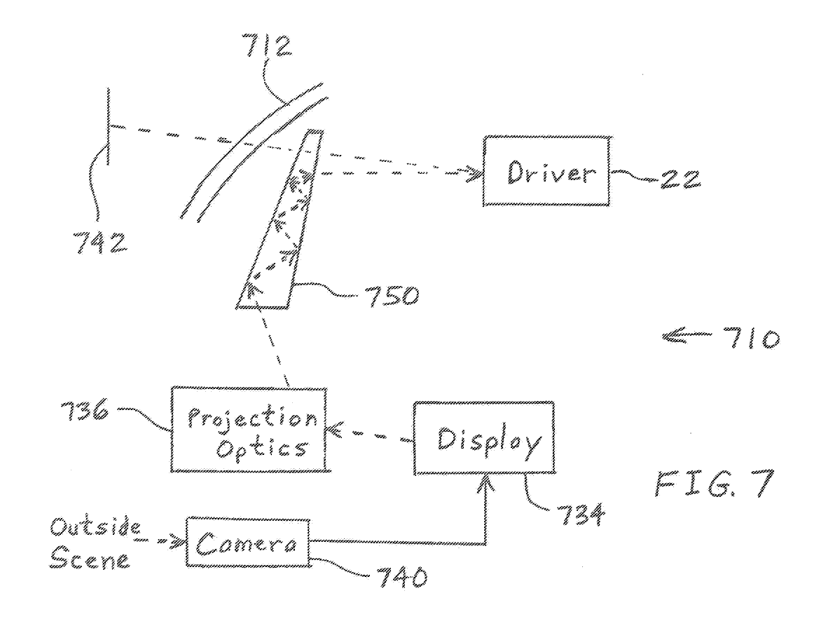

FIG. 7 illustrates yet another example embodiment of a windshield/window video display arrangement 710 of the present invention, including a front windshield 712, a transparent wedge 750, a video camera 740, a display screen 734, and projection optics 736 creating a virtual image 742 that appears to a human driver 22 to be disposed outside of windshield 712. Windshield/window video display arrangement 710 provides a HUD that uses wedge optics 750 to create virtual image 742 to be seen by driver 22. Transparent wedge 750 is used to present the image captured by side-view camera 740 superimposed over the visible scene outside front windshield 712. Virtual image 742 is seen by driver 22 near an A-pillar, on the inboard side. The configuration of wedge 750 is such that the light reflects internally within wedge 750 at increasing angles with successive reflections until the critical angle is exceeded and the light emerges from wedge 750 and can be seen by driver 22.

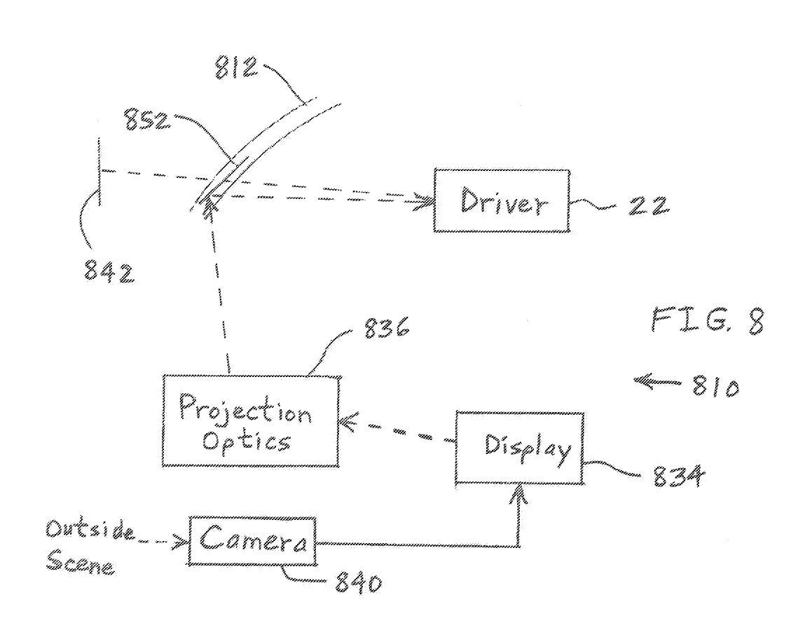

FIG. 8 illustrates yet another example embodiment of a windshield/window video display arrangement 810 of the present invention, including a front windshield 812, a diffractive optical element 852, a video camera 840, a display screen 834, and projection optics 836 creating a virtual image 842 that appears to a human driver 22 to be disposed outside of windshield 812. Windshield/window video display arrangement 810 provides a HUD employing a diffractive optical element (DOE) 852 that is embedded in windshield 812 to create virtual image 842 that can be seen by driver 22. Diffractive optical element or holographic optical element 852 is embedded in the plastic layer between the two outer glass layers in windshield 812, and is used to superimpose the image captured by side-view camera 840 over the visible scene outside windshield 812 as viewed by driver 22. The image may be seen by driver 22 near an A-pillar on the inboard side.

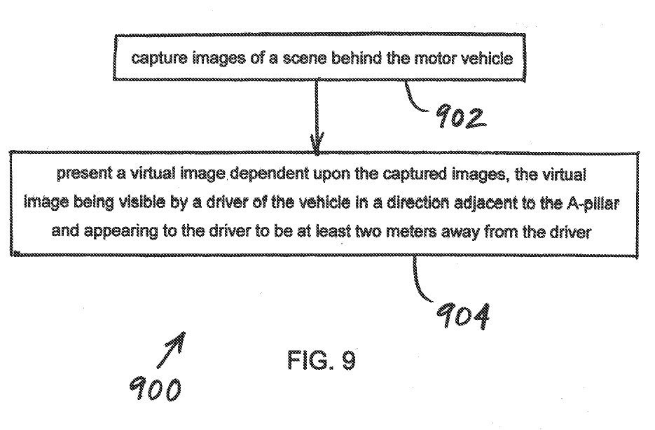

FIG. 9 illustrates one example embodiment of a method 900 of the invention for presenting information to a driver of a motor vehicle having an A-pillar disposed between a side view window and a windshield. In a first step 902, images of a scene behind the motor vehicle are captured. For example, video camera 840 may capture images of a scene behind a motor vehicle that is typically visible on a side view mirror.

In a final step 904, a virtual image is presented dependent upon the captured images. The virtual image is visible by a driver of the vehicle in a direction adjacent to the A-pillar and appears to the driver to be at least two meters away from the driver. For example, display screen 834 and projection optics 836 may present a virtual image based on a video signal from camera 840. Projection optics 836 may reflect a light field off of windshield 812 at a location on windshield 812 that is adjacent to either A-pillar 14 or A-pillar 18. Thus, the resulting virtual image 842 may appear in a direction from driver 22 that passes adjacent to the A-pillar (e.g., an imaginary line from the eyes of driver 22 to the virtual image 842 may pass less than 6-12 inches from the A-pillar at its closest point). This virtual image 842 may appear to driver 22 to be at least two meters away from driver 22.

Some of the embodiments of the present invention include optical elements that may either be embedded in the windshield or fabricated as a stand-alone component separate from the windshield. The apparent distance of the image from the viewer is greater than the distance to the combiner, windshield, or other optical element used to direct the light to the driver. Controls may be provided to enable the driver to ensure that the side-view image is visible, and/or to configure the image to his personal preferences. In various embodiments, these controls enable the driver to adjust the brightness of the image relative to the brightness of the background scene; enable the driver to modify the color gamut of the image; and/or enable the driver to modify attributes of the border around the image such as brightness, color, width, and time dependence. The controls may enable the driver to adjust the orientation of an optical element so the driver's eyes are within the eye box. The controls may be used to adjust the direction or magnification of the camera view, according to the driver's personal preference. The controls may also enable the driver to select extra information to present in the image such as safety warnings or parking aids.

The invention encompasses various methods to produce a video image superposed over an outside scene viewable by a driver through a windshield. These methods, examples of which are described below, may be used to show information in addition to a video image.

In a first embodiment, a combiner HUD creates a virtual image by reflecting light from a transparent combiner, to be seen by the driver, as shown in FIG. 4. The driver may see a virtual image past the combiner and localized on a plane outside the windshield. Within the scope of the present invention, the combiner HUD could either be attached to the A-pillar or be disposed on top of the dash.

In a second embodiment, a windshield HUD creates a virtual image by reflecting light from the windshield, to be seen by the driver, as shown in FIG. 5. The driver may see the virtual image past the combiner and localized on a plane outside the windshield. To implement a windshield HUD near an A-pillar, the driver should be able to see in the windshield the reflected image of the portion of the dash from which the image is projected. There also should be sufficient volume available beneath the dash to package the optics needed to create the HUD image.

In a third embodiment, a waveguide HUD creates a virtual image with a transparent waveguide (made of a material such as clear plastic), as shown in FIG. 6. A grating (such as a volume phase grating) inserts light from a display into the waveguide. After insertion, the light reflects between the two internal faces at less than the critical angle for total internal reflection. A similar grating extracts the light from the waveguide. The waveguide can be configured so the driver sees a virtual image past the waveguide.

In a fourth embodiment, wedge optics can be used to create a virtual image that the driver sees behind a wedge of transparent material, as shown in FIG. 7. A projector inputs the light into the base of the wedge so it reflects at an angle that is less than the critical angle of total internal reflection in the material. As the light reflects back and forth between the opposing sides of the wedge, the angle of incidence increases with each reflection. Eventually the angle is large enough for the light to escape the wedge. The display can be configured so the viewer sees a virtual image behind the transparent display.

In a fifth embodiment, a holographic optical element (HOE) made of a transparent material can be used to create a virtual image that appears to come from behind the HOE, as shown in FIG. 8. Light is projected toward the HOE. The HOE is configured to diffract the light in the appropriate direction. The HOE can be configured to mimic the effect of additional optical elements such as lenses or mirrors, to obtain the desired effect.

In summary, embodiments of the present invention include: (1) as shown in FIG. 1, a HUD utilizing waveguide optics is mounted to an A-pillar in a vehicle, on the inboard side, and displays a video image similar to the scene that would conventionally be reflected from the side-view mirror on that side of the vehicle; (2) a windshield HUD, as shown in FIG. 5, is implemented near an A-pillar in a vehicle, on the inboard side, so the driver sees the light from the HUD, reflected from the windshield near the A-pillar, as a virtual image showing a video image similar to the scene that would conventionally be reflected from the side-view mirror on that side of the vehicle; (3) as shown in FIG. 7, a HUD utilizing wedge optics, is mounted to an A-pillar in a vehicle, on the inboard side, and displays a video image similar to the scene that would conventionally be reflected from the side-view mirror on that side of the vehicle; (4) as shown in FIG. 4, a combiner HUD is mounted to an A-pillar in a vehicle, on the inboard side, and displays a video image similar to the scene that would conventionally be reflected from the side-view mirror on that side of the vehicle; (5) a combiner HUD is mounted on the dashboard, adjacent to an A-pillar in a vehicle, oriented so the virtual image can be seen by the driver, and displays a video image similar to the scene that would conventionally be reflected from the side-view mirror on that side of the vehicle (6) a holographic optical element is integrated into the plastic inner layer in the front windshield near the A-pillar, as shown in FIG. 8, and is designed to act as a HUD, in that the driver can see the projected image as a virtual image outside of the windshield, displaying a video image similar to the scene that would conventionally be reflected to the driver from the side-view mirror on that side of the vehicle; (7) a system as described previously with means to control the brightness of a HUD, adjacent to an A-pillar, to ensure that the driver is able to see the video image with adequate contrast ratio, as shown in FIG. 3; (8) a system as described previously, in which the displayed image has a visible perimeter, as shown in FIG. 2; (9) a system as described previously, in which the driver is provided with at least one control to set the ratio of the image brightness relative to the brightness of the outside scene; (10) a system as described previously, in which the driver is provided with at least one control to set the absolute image brightness; (11) a system as described previously, in which the driver is provided with at least one means to control the color gamut of the video image; (12) a system as described previously, in which the driver is provided with a means to control the brightness of the perimeter of the video image; (13) a system as described previously, in which the driver is provided with a means to control the color of the perimeter of the video image; (14) a system as described previously, in which the brightness of the outside scene is sensed and the measured value is used to automatically adjust the brightness of the image of the side-view scene as presented to the driver, (15) a system as described previously, in which the driver is provided with a means to adjust the location of the eye box of the HUD to match the location of the driver's eyes, so that the HUD image is visible to the driver; and (16) a system as described previously, in which the system determines the location of the driver's eyes and automatically adjusts the location of the eye box of the HUD to match the location of the driver's eyes.

The apparent distance from the driver to the image plane of the displayed image, known as the virtual image distance (VID), is larger than the distance from the driver to the final optical element (such as the windshield for a windshield HUD). The VID may be an adjustable parameter of the optical design. It may be advantageous for the VID to be greater than a threshold distance, such as two meters, to reduce the time required for the driver to refocus after glancing between the outside scene and the side-view display. In some embodiments it may be possible to adjust the VID after the optical system has been fabricated, to indicate, for example, the distance to a nearby vehicle. In an embodiment in which the VID is adjustable, the VID may be adjusted automatically based on a sensor input, or it may be selected by the driver to match his personal preference.

The image source for a particular side-view display can be a camera mounted on the respective side of the vehicle. In one embodiment, the driver is provided with controls to adjust one or more of: (1) the direction of view, (2) the magnification of the view, and (3) the presentation of compressed visual information in a band around one or more sides of the display or in a patch in the display, to enable the driver to detect an object outside the normal field of view. Also, other useful information can be displayed in a side-view display. For example, a symbol may be used to warn the driver that another vehicle is in the blind spot on that side.

To see a HUD or display of the invention, the driver may need to turn his head from the forward direction, but not as much as would be necessary to see the image in the respective conventional side-view mirror that is replaced. Accordingly, less driver head-motion is required for the driver to monitor the left and right side of the vehicle. This may improve traffic safety by making it quicker and easier for the driver to look before changing lanes. The driver can confirm the image with a direct view of the blind spot, if desired, with additional head motion.

One advantage of using a video display instead of a side-view mirror is that it reduces the vehicle's aerodynamic drag and thereby improves fuel economy.

A second advantage of using a video display instead of a side-view mirror is that it avoids accidents in which a side-view mirror strikes another object. This improves traffic safety.

A third advantage of using a video display instead of a side-view mirror is that it prevents having the camera-view direction of the side-view display be inappropriate for safe driving. The orientation of a conventional side-view mirror is often incorrect in the real world. Limiting the possible range of orientation can improve traffic safety.

A camera image may be presented to the driver by a display mounted on the A-pillar. On the driver side, if the display is close to the driver, the driver may need to refocus his eyes to view the camera image, which may take enough extra time to significantly impact traffic safety. In the present invention, the side-view image is a virtual image located past the windshield. Consequently, the side-view display according to the present invention decreases the time needed for the driver to refocus his eyes to see the image, with an expected traffic safety improvement.

The present invention may reduce the head motion of the driver that is needed to see information that would otherwise be presented in the side-view mirror. This may improve traffic safety by increasing the driver's situational awareness.

The present invention is an improvement over a conventional side-view mirror in that the driver's view of the outside scene is not blocked by the side-view mirror. This may improve traffic safety and may be perceived as a benefit by the vehicle owner.

The present invention may eliminate the problem of fitting the side-view mirror image into the size constraint of the A-pillar.

In an alternative embodiment, the position of the displayed image is on the outboard side of the A-pillar away from the driver instead of on the inboard side, such that the image overlays the position of a conventional side-view mirror.

There are many ways to enhance the value of the displayed image, including augmented reality features such as pedestrian warnings, distance markings, and information displayed by the color, brightness, and time dependence of the image perimeter.

There are many possible camera configurations, means to transfer the camera image to a display, and display technologies that could be used to implement this invention.

The foregoing description may refer to “motor vehicle”, “automobile”, “automotive”, or similar expressions. It is to be understood that these terms are not intended to limit the invention to any particular type of transportation vehicle. Rather, the invention may be applied to any type of transportation vehicle whether traveling by air, water, or ground, such as airplanes, boats, etc.

The foregoing detail description is given primarily for clearness of understanding and no unnecessary limitations are to be understood therefrom for modifications can be made by those skilled in the art upon reading this disclosure and may be made without departing from the spirit of the invention.

What is claimed is:

1. A motor vehicle, comprising:
a side view window;
a windshield;
an A-pillar disposed between the side view window and the windshield; and
a virtual image projection arrangement configured to present a virtual image visible by a driver of the vehicle in a direction adjacent to the A-pillar and appearing to the driver to be at least two meters away from the driver.

2. The vehicle of claim 1 wherein the virtual image projection arrangement is configured to present the virtual image such that the virtual image is visible by the driver in a direction inbound of the A-pillar.

3. The vehicle of claim 1 wherein the virtual image projection arrangement is configured to present the virtual image such that the virtual image is visible by the driver in a direction outbound of the A-pillar.

4. The vehicle of claim 1 wherein the virtual image projection arrangement includes a head up display having waveguide optics, at least a portion of the head up display being mounted to the A-pillar.

5. The vehicle of claim 1 wherein the virtual image projection arrangement includes a head up display having wedge optics, at least a portion of the head up display being mounted to the A-pillar.

6. The vehicle of claim 1 wherein the virtual image projection arrangement includes a combiner head up display, at least a portion of the head up display being mounted to the A-pillar.

7. The vehicle of claim 1 wherein the virtual image projection arrangement includes a combiner head up display disposed adjacent to the A-pillar, at least a portion of the head up display being mounted to a dashboard of the motor vehicle.

8. The vehicle of claim 1 wherein the virtual image projection arrangement includes a transparent display disposed adjacent to the A-pillar and on an inboard side of the A-pillar.

9. The vehicle of claim 1 wherein the virtual image projection arrangement includes a holographic optical element integrated into a plastic inner layer in the windshield near the A-pillar, the holographic optical element being disposed adjacent to the A-pillar.

10. The vehicle of claim 1 wherein the virtual image has a visible perimeter.

11. The vehicle of claim 10 further comprising a control device configured to enable the driver to control a brightness of the visible perimeter of the virtual image.

12. A method of presenting information to a driver of a motor vehicle having an A-pillar disposed between a side view window and a windshield, the method comprising the steps of:
capturing images of a scene behind the motor vehicle; and
presenting a virtual image dependent upon the captured images, the virtual image being visible by a driver of the vehicle in a direction adjacent to the A-pillar and appearing to the driver to be at least two meters away from the driver.

13. The method of claim 12 wherein the virtual image is presented such that the virtual image is visible by the driver in a direction inbound of the A-pillar.

14. The method of claim 12 wherein the virtual image is presented such that the virtual image is visible by the driver in a direction outbound of the A-pillar.

15. The method of claim 12 wherein the virtual image is presented by a head up display having waveguide optics, the method comprising mounting at least a portion of the head up display to the A-pillar.

16. The method of claim 12 wherein the virtual image is presented by a head up display having wedge optics, the method comprising mounting at least a portion of the head up display to the A-pillar.

17. The method of claim 12 wherein the virtual image is presented by a combiner head up display having wedge optics, the method comprising mounting at least a portion of the head up display to the A-pillar.

18. The method of claim 12 wherein the virtual image is presented by a combiner head up display disposed adjacent to the A-pillar, the method comprising mounting at least a portion of the head up display to a dashboard of the motor vehicle.

19. The method of claim 12 wherein the virtual image is presented by a transparent display disposed adjacent to the A-pillar and on an inboard side of the A-pillar.

20. The method of claim 12 wherein the virtual image is presented by a holographic optical element integrated into a plastic inner layer in the windshield near the A-pillar, the holographic optical element being disposed adjacent to the A-pillar.

21. The method of claim 12 wherein the virtual image has a visible perimeter.

22. The method of claim 12 further comprising enabling the driver to control a brightness of the visible perimeter of the virtual image.

23. A motor vehicle, comprising:
an external camera positioned to capture images in a rearward direction;
a side view window;
a windshield;
an A-pillar disposed between the side view window and the windshield;
an electronic processor configured to receive the images captured by the camera; and
a virtual image projection arrangement communicatively coupled to the electronic processor and configured to present a virtual image dependent upon the images captured by the camera, the virtual image being visible by a driver of the vehicle in a direction adjacent to and inboard of the A-pillar, and appearing to the driver to be disposed at a distance of at least one foot beyond the windshield.

24. The vehicle of claim 23 wherein the virtual image projection arrangement includes a head up display having waveguide optics, at least a portion of the head up display being mounted to the A-pillar.

25. The vehicle of claim 23 wherein the virtual image projection arrangement includes a head up display having wedge optics, at least a portion of the head up display being mounted to the A-pillar.

26. The vehicle of claim 23 wherein the virtual image projection arrangement includes a combiner head up display, at least a portion of the head up display being mounted to the A-pillar.

27. The vehicle of claim 23 wherein the virtual image projection arrangement includes a combiner head up display disposed adjacent to the A-pillar, at least a portion of the head up display being mounted to a dashboard of the motor vehicle.

28. The vehicle of claim 23 wherein the virtual image projection arrangement includes a holographic optical element integrated into a plastic inner layer in the windshield near the A-pillar, the holographic optical element being disposed adjacent to the A-pillar.

29. The vehicle of claim 23 wherein the virtual image has a visible perimeter.

30. The vehicle of claim 29 further comprising a control device configured to enable the driver to control a brightness of the visible perimeter of the virtual image.
